(19) United States
(12) Patent Application Publication
(10) Pub. No.: US 2025/0004207 A1
(43) Pub. Date: Jan. 2, 2025

(54) OPTICAL MULTIPLEXER

(71) Applicant: SANTEC HOLDINGS CORPORATION, Aichi (JP)

(72) Inventor: Yasuki SAKURAI, Aichi (JP)

(21) Appl. No.: 18/682,036

(22) PCT Filed: Aug. 10, 2021
(86) PCT No.: PCT/JP2021/029516

§ 371 Date: Sep. 16, 2024

(51) Int. Cl. G02B 6/35

(52) U.S. Cl. CPC G02B 6/3518

(57) ABSTRACT

In an optical multiplexer, an optical dispersion element separates, into a plurality of wavelength components, first input light from a first input port and second input light from a second input port. A reflection mirror includes first and second reflection elements. A first output port is provided in a propagation path of reflected light corresponding to a first wavelength band of the first input light by the first reflection element. A second output port is provided in a propagation path of reflected light corresponding to a second wavelength band of the first input light by the second reflection element. The second input port is arranged at a position where third reflected light that is reflected light by the second reflection element of the second wavelength band of the second input light is optically coupled to the first output port and output from the first output port.

### TECHNICAL FIELD

The present disclosure relates to an optical multiplexer.

### BACKGROUND ART

A wavelength division multiplexing (WDM) network, which is a communication network using a WDM optical communication technology is already known. In the WDM network, a branch point is provided with an optical add drop multiplexer (OADM) that enables branch/insertion of an optical signal.

As an example of the OADM, a wavelength-tunable OADM that can change a wavelength band that is a branch/insertion target is known. Examples of wavelength-tunable OADM include an OADM equipped with a wavelength-tunable filter and an OADM equipped with a wavelength selection switch (WSS). The wavelength selection switch includes a MEMS mirror electrically controlled by a controller, for example, and a spatial optical system, and is configured to be able to transmit an arbitrary wavelength of an optical signal to an arbitrary path (see, for example, Patent Document 1).

### PRIOR ART DOCUMENTS

### Patent Documents

Patent Document 1: Japanese Unexamined Patent Application Publication No. 2015-156015

### SUMMARY OF THE INVENTION

### Problems to be Solved by the Invention

In the OADM equipped with the wavelength-tunable filter, an optical signal is branched/inserted by a coupler, and a wavelength band that is a branch/insertion target is switched by the wavelength-tunable filter. With this OADM, the optical signal passes through two couplers and one wavelength-tunable filter before being output through a process of branch/insertion. A signal loss of 3 dB occurs in each of the couplers, and a signal loss of 2 dB occurs in the wavelength-tunable filter.

Although the OADM equipped with the wavelength selection switch is excellent in wavelength selectivity, the scale of the optical component and the electronic component to be equipped is large and complicated, and therefore the OADM is more expensive and has a higher failure rate than other OADMs.

Therefore, according to one aspect of the present disclosure, it is desirable to be able to provide a new optical multiplexer that is excellent overall in terms of insertion loss, reliability, and cost.

### Means for Solving the Problems

According to one aspect of the present disclosure, an optical multiplexer is provided. The optical multiplexer includes a first input port, a second input port, an optical dispersion element, a reflection mirror, a first output port, and a second output port.

The optical dispersion element is provided in a propagation path of first input light from the first input port and second input light from the second input port. The optical dispersion element is configured to separate each of first input light and second input light into a plurality of wavelength components by dispersing the first input light and the second input light in a predetermined wavelength dispersion direction.

The reflection mirror includes a first reflection element configured to reflect a group of wavelength components corresponding to a first wavelength band among the plurality of wavelength components separated by the optical dispersion element, and a second reflection element configured to reflect a group of wavelength components corresponding to a second wavelength band different from the first wavelength band in a direction different from the group of wavelength components corresponding to the first wavelength band of corresponding input light.

The first output port provided in a propagation path of first reflected light that is reflected light by the first reflection element of a group of wavelength components corresponding to the first wavelength band of the first input light, and configured to output the first reflected light.

The second output port provided in a propagation path of second reflected light that is reflected light by the second reflection element of a group of wavelength components corresponding to the second wavelength band of the first input light, and configured to output the second reflected light.

The reflection mirror reflects incident light in a direction different from an incident direction, and has a configuration in which the first reflection element and the second reflection element are arranged such that the first reflected light and the second reflected light propagate away in a direction perpendicular to the wavelength dispersion direction.

The second input port is arranged at a position separated from the first input port in a direction perpendicular to the wavelength dispersion direction so that third reflected light that is reflected light by the second reflection element of a group of wavelength components corresponding to the second wavelength band of the second input light is optically coupled to the first output port and output from the first output port.

This optical multiplexer can, without using a coupler, spatially separate a group of wavelength components in the first wavelength band and a group of wavelength components in the second wavelength band included in the first input light, and output them from the first output port and the second output port. Then, without using a coupler, the optical multiplexer can output, from the first output port, a group of wavelength components in the second wavelength band included in the second input light in addition to the group of wavelength components in the first wavelength band included in the first input light. This optical multiplexer can be achieved with a relatively simple structure.

Therefore, according to one aspect of the present disclosure, it is possible to provide a new optical multiplexer that is excellent overall in terms of insertion loss, reliability, and cost.

According to another aspect of the present disclosure, an optical multiplexer may include a mirror array, a drive element, and a controller. The mirror array may include a plurality of reflection mirrors, and each of the plurality of reflection mirrors may be configured as a reflection mirror described above including the first reflection element and the second reflection element.

The drive element may be configured to displace the mirror array. The controller may be configured to control the arrangement of the mirror array through the drive element. Each of the plurality of reflection mirrors may be a reflection mirror in which the first reflection element and the second reflection element are arranged such that combinations of the first wavelength band and the second wavelength band are different from each other between the plurality of reflection mirrors.

The controller may be configured to control the arrangement of the mirror array such that the first input light and the second input light dispersed by the optical dispersion element are incident selectively on one designated reflection mirror among the plurality of reflection mirrors.

According to the configuration including such movable mirror array, it is possible to provide a wavelength-tunable optical multiplexer that can switch the wavelength band of the signal component to be branched (i.e., drop)/inserted (i.e., add).

According to another aspect of the present disclosure, an optical multiplexer may include a mirror array, an optical deflector, and a controller. The mirror array may include a plurality of reflection mirrors, and each of the plurality of reflection mirrors may be configured as a reflection mirror described above including the first reflection element and the second reflection element. The optical deflector is between the mirror array and the optical dispersion element, and configured to be able to change a propagation direction to the mirror array of the first input light and the second input light dispersed by the optical dispersion element.

The controller may be configured to control the propagation direction by control of the optical deflector. Each of the plurality of reflection mirrors may be a reflection mirror in which the first reflection element and the second reflection element are arranged such that combinations of the first wavelength band and the second wavelength band are different from each other between the plurality of reflection mirrors.

The controller may control the optical deflector such that the first input light and the second input light dispersed by the optical dispersion element are incident selectively on one designated reflection mirror among the plurality of reflection mirrors.

The optical deflector may be a movable mirror. In this case, the controller may control the propagation direction by controlling the angle of a reflection surface of the movable mirror.

Even a configuration using such optical deflector can provide a wavelength-tunable optical multiplexer that can switch the wavelength band of the signal component to be branched/inserted.

### BRIEF DESCRIPTION OF THE DRAWINGS

FIG. 1 is a diagram describing the operation of an OADM.

FIG. 2 is a block diagram showing a configuration of an optical multiplexer of a first embodiment.

FIGS. 3A and 3B are views showing an internal configuration of the optical multiplexer of the first embodiment as viewed from a direction parallel to a wavelength dispersion direction.

FIG. 4 is a view showing an internal configuration of the optical multiplexer of the first embodiment as viewed from a direction perpendicular to the wavelength dispersion direction.

FIGS. 5A and 5B are views showing arrangement of a first reflection element and a second reflection element.

FIG. 6 is a view showing an internal configuration of an optical multiplexer of a second embodiment as viewed from a direction parallel to the wavelength dispersion direction.

FIG. 7 is a diagram describing an example of combinations of a first wavelength band and a second wavelength band achieved by a mirror array.

FIG. 8A is a block diagram showing a configuration of an optical multiplexer of a third embodiment, and FIG. 8B is a view showing an internal configuration of the optical multiplexer of the third embodiment as viewed from a direction parallel to the wavelength dispersion direction.

FIG. 9A is a block diagram showing a configuration of an optical multiplexer of a fourth embodiment, and FIG. 9B is a view showing an internal configuration of the optical multiplexer of the fourth embodiment as viewed from a direction parallel to the wavelength dispersion direction.

FIG. 10 is a view showing an internal configuration of an optical multiplexer of a fifth embodiment as viewed from a direction parallel to the wavelength dispersion direction.

### EXPLANATION OF REFERENCE NUMERALS

100, 200, 300, 400, 500 optical multiplexer, 110 optical system, 130, 530 transmission type diffraction grating, 150, 510 lens, 170, 270, 370, 570 reflection mirror, 171, 371 first reflection element, 172, 372 second reflection element, 260, 560 mirror array, 280, 580 drive source, 290, 590 controller, 373 third reflection element, 374 fourth reflection element, 540 movable mirror, P_IN first input port, P_IN1, P_IN2 main input port, P_AD second input port, P_AD1, P_AD2, P_AD3 add input port, P_TH first output port, P_TH1, P_TH2 through output port, P_DR second output port, P_DR1, P_DR2, P_DR3 drop output port.

### MODE FOR CARRYING OUT THE INVENTION

Illustrative embodiments of the present disclosure will be described below with reference to the drawings.

An optical multiplexer 100, 200, 300, 400, 500 according to an illustrative embodiment of the present disclosure is an optical multiplexer suitable for use as an OADM 10 in a WDM network.

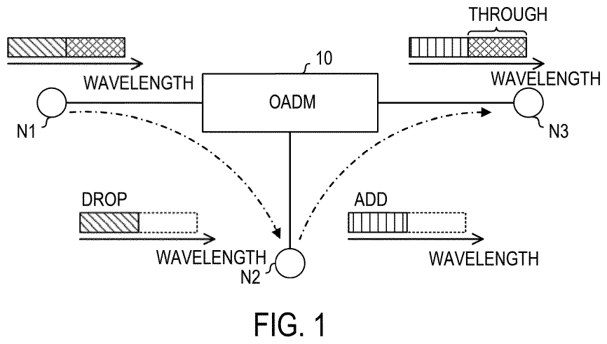

The OADM 10 is provided at a branch point of the WDM network, and performs branch and insertion of an optical signal. According to the WDM network illustrated in FIG. 1, a first communication node N1, a second communication node N2, and a third communication node N3 are connected via the OADM 10.

Optical communication is performed between the first communication node N1 and the third communication node N3 through a first channel corresponding to the first wavelength band, and optical communication is performed between the first communication node N1 and the second communication node N2 through a second channel corresponding to the second wavelength band.

In the process of transmitting an optical signal from the first communication node N1 to the third communication node N3, the OADM 10 drops (DROP) and transmits, to the second communication node N2, a signal component of the second channel included in the optical signal. The OADM 10 passes through (THRU) and transmits, to the third communication node N3, a signal component of the first channel.

The OADM 10 adds (ADD) and transmits, to the third communication node N3, a signal component of the second channel from the second communication node N2 to the optical signal from the first communication node N1 from which the signal component of the second channel has been dropped.

### First Embodiment

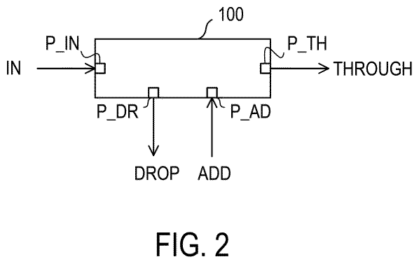

As shown in FIG. 2, the optical multiplexer 100 of the first embodiment suitable for use as the OADM 10 described above includes a first input port P_IN, a second input port P_AD, a first output port P_TH, and a second output port P_DR.

The optical multiplexer 100 outputs, from the first output port P_TH, a signal component of the first wavelength band of an optical signal input from the first input port P_IN, and outputs, from the second output port P_DR, a signal component of the second wavelength band of the optical signal input from the first input port P_IN. The optical multiplexer 100 further outputs, from the first output port P_TH, a signal component of the second wavelength band of an optical signal input from the second input port P_AD.

Hereinafter, an optical signal input from the first input port P_IN is expressed as an in signal, an optical signal input from the second input port P_AD is expressed as an add signal, an in signal output from the first output port P_TH is expressed as a through signal, and an optical signal output from the second output port P_DR is expressed as a drop signal.

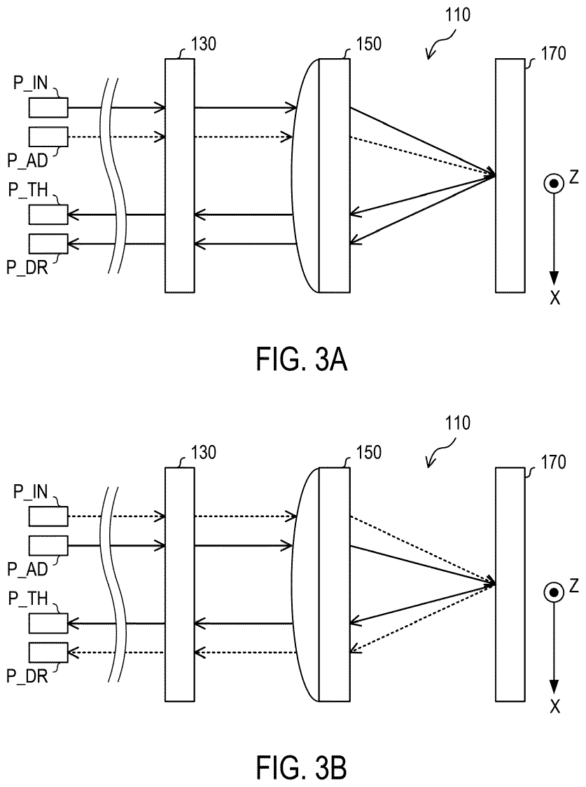

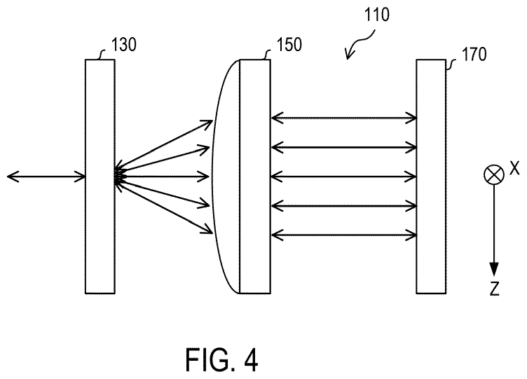

The optical multiplexer 100 internally includes an optical system 110 shown in FIGS. 3A, 3B, and 4. This optical system 110 includes a transmission type diffraction grating 130 as an optical dispersion element, a lens 150, and a reflection mirror 170.

As shown in FIGS. 3A and 3B, the transmission type diffraction grating 130 is provided in a propagation path of optical signals input from the first input port P_IN and the second input port P_AD (i.e., an in signal and an add signal).

The transmission type diffraction grating 130 is configured to separate an optical signal into a plurality of wavelength components by wavelength-dispersing, in a predetermined direction, the optical signal (i.e., each of the in signal and the add signal) input from each of the first input port P_IN and the second input port P_AD. When transmitting through the transmission type diffraction grating 130, the optical signal is spatially separated into the plurality of wavelength components in a Z direction shown in FIGS. 3A and 3B.

FIGS. 3A and 3B show an internal configuration of the optical multiplexer 100 viewed from a direction parallel to the Z direction, which is a wavelength dispersion direction. In particular, FIG. 3A conceptually shows, by a solid arrow, propagation of an in signal input from the first input port P_IN, and conceptually shows, by a broken arrow for reference, part of propagation of an add signal input from the second input port P_AD. FIG. 3B conceptually shows, by a solid arrow, propagation of an add signal input from the second input port P_AD, and conceptually shows, by a broken arrow for reference, part of propagation of an in signal input from the first input port P_IN.

As understood from FIGS. 3A and 3B, the first input port P_IN and the second input port P_AD are arranged apart at a predetermined interval in an X direction perpendicular to the Z direction, which is the wavelength dispersion direction. Due to this, the in signal from the first input port P_IN and the add signal from the second input port P_AD enter the transmission type diffraction grating 130 in a state of being spatially separated in the X direction.

The transmission type diffraction grating 130 spatially separates, in the Z direction as shown in FIG. 4, a plurality of wavelength components included in each of the in signal and the add signal entering in the state of being spatially separated in the X direction.

FIG. 4 shows an internal configuration of the optical multiplexer 100 viewed from a direction parallel to the X direction perpendicular to the wavelength dispersion direction. A plurality of arrows extending from the transmission type diffraction grating 130 shown in FIG. 4 conceptually show that the optical signal entering the transmission type diffraction grating 130 is wavelength-dispersed in the Z direction and propagates to the lens 150. That is, the in signal and the add signal transmitted through the transmission type diffraction grating 130 propagate to the lens 150 in a state where the plurality of wavelength components are spatially separated in the Z direction.

The lens 150 is designed and arranged such that the wavelength-dispersed in signal and add signal are focused on the reflection surface of the reflection mirror 170.

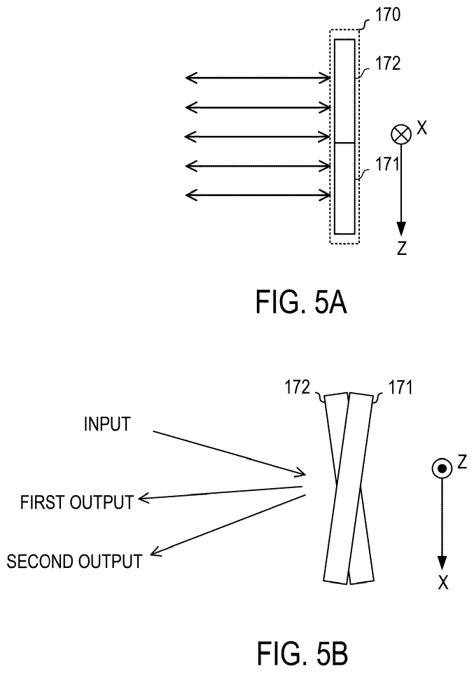

As shown in FIG. 5A, the reflection mirror 170 includes a first reflection element 171 and a second reflection element 172 arrayed in the Z direction. The first reflection element 171 and the second reflection element 172 are arranged in the Z direction such that, of the wavelength-dispersed in signal and add signal transmitted through the lens 150 and propagating to the reflection mirror 170, a first signal component that is a group of wavelength components corresponding to the first wavelength band is incident on the first reflection element 171, and a second signal component that is a group of wavelength components corresponding to the second wavelength band is incident on the second reflection element 172.

The first reflection element 171 and the second reflection element 172 have reflection surfaces inclined with respect to the X direction as shown in FIG. 5B. Specifically, the first reflection element 171 has a reflection surface inclined with respect to the X direction at an angle different from the reflection surface of the second reflection element 172.

The first signal component of the in signal is reflected by a reflection angle corresponding to an incidence angle on the reflection surface of the first reflection element 171, and the second signal component of the in signal is reflected by a reflection angle corresponding to an incidence angle on the reflection surface of the second reflection element 172. The incidence angles and the reflection angles have angles that are not zero with respect to the normal directions of the reflection surfaces.

As described above, the inclination angle of the reflection surface of the first reflection element 171 with respect to the X direction is different from the inclination angle of the reflection surface of the second reflection element 172 with respect to the X direction. Therefore, the incidence angle and the reflection angle of the first signal component with respect to the reflection surface of the first reflection element 171 are different from the incidence angle and the reflection angle of the second signal component with respect to the reflection surface of the second reflection element 172.

As a result, the first signal component of the in signal incident on and reflected by the reflection surface of the first reflection element 171 is reflected in a direction different from the incident direction, the direction different from the reflection direction of the second signal component of the in signal incident on and reflected by the reflection surface of the second reflection element 172, and propagates in a state of being spatially separated in the X direction from the second signal component of the in signal.

Specifically, the reflection surface of the first reflection element 171 is angled such that the propagation path of the first signal component of the in signal reflected by the first reflection element 171 is optically coupled to the first output port P_TH. The reflection surface of the second reflection element 172 is angled such that the propagation path of the second signal component of the in signal reflected by the second reflection element 172 is optically coupled to the second output port P_DR.

The first output port P_TH is provided in the propagation path of the reflected light by the first reflection element 171 of the first signal component of the in signal, and the second output port P_DR is provided in the propagation path of the reflected light by the second reflection element 172 of the second signal component of the in signal.

With this optical design, the first signal component of the in signal reflected by the first reflection element 171 propagates toward the first output port P_TH and is output from the first output port P_TH. The second signal component of the in signal reflected by the second reflection element 172 propagates in a direction toward the second output port P_DR and is output from the second output port P_DR.

Furthermore, since the relative position in the X direction of the second input port P_AD with respect to the first input port P_IN is characteristic, the second signal component of the add signal reflected by the second reflection element 172 propagates toward not the second output port P_DR but the first output port P_TH, and is output from the first output port P_TH.

That is, in the present embodiment, the relative position in the X direction of the second input port P_AD with respect to the first input port P_IN is adjusted such that the propagation path of the second signal component of the add signal reflected by the second reflection element 172 is optically coupled to the first output port P_TH.

By adjustment of this relative position, the incidence angle and the reflection angle of the in signal and the add signal with respect to the reflection surface of the second reflection element 172 are adjusted, and the optical multiplexer 100 is designed such that the second signal component of the in signal propagates to the second output port P_DR, while the second signal component of the add signal propagates to the first output port P_TH. Additionally, the optical multiplexer 100 is designed such that the first signal component of the add signal is not optically coupled to any output port.

According to the optical multiplexer 100 of the present embodiment described above, the reflection mirror 170 spatially separates, in the X direction, the in signal wavelength-dispersed in the Z direction by the transmission type diffraction grating 130 into the first signal component corresponding to the first wavelength band and the second signal component corresponding to the second wavelength band by the first reflection element 171 and the second reflection element 172.

Therefore, the optical multiplexer 100 can generate the through signal and the drop signal by branching the in signal without a coupler. That is, according to the optical multiplexer 100, by spatially separate the first signal component and the second signal component included in the in signal without using a coupler, it is possible to output the first signal component as the through signal from the first output port P_TH, and to output the second signal component as the drop signal from the second output port P_DR.

Furthermore, the second input port P_AD is arranged at a position separated in the X direction from the first input port P_IN so that the reflected light by the second reflection element 172 of the second signal component corresponding to the second wavelength band of the add signal is optically coupled with the first output port P_TH and output from the first output port P_TH.

Therefore, the optical multiplexer 100 can insert the add signal of the second wavelength band into the through signal of the first wavelength band and output it from the first output port P_TH without a coupler. Furthermore, as shown in FIGS. 3A, 3B, and 4, the optical system 110 of the optical multiplexer 100 is very simple. Therefore, according to the present embodiment, it is possible to provide the optical multiplexer 100 that is excellent overall in terms of insertion loss, reliability, and cost.

As a modification, in order to configure the optical multiplexer 100 of the first embodiment as a wavelength-tunable optical multiplexer, the reflection mirror 170 may be configured by an array of MEMS mirrors arrayed in the wavelength dispersion direction. In the case where the reflection mirror 170 is configured by the MEMS mirror array, the arrangement of the first reflection element 171 and the second reflection element 172 achieved by the MEMS mirror array can be switched by control of the MEMS mirror array, and the first wavelength band used for the through signal and the second wavelength band used for the add/drop signal can be changed.

### Second Embodiment

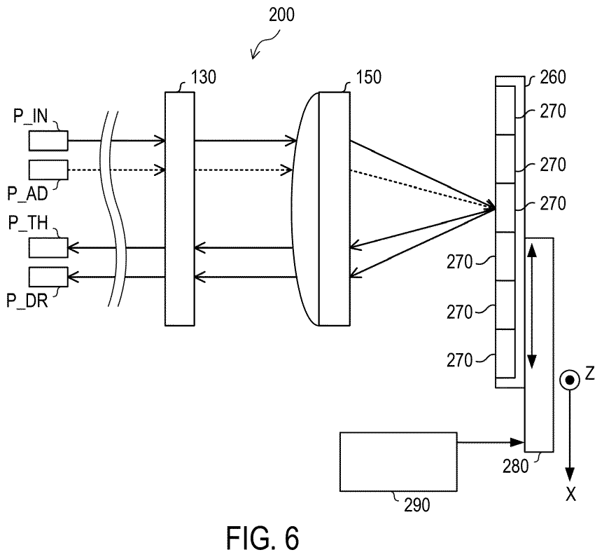

An optical multiplexer 200 of the second embodiment shown in FIG. 6 is an optical multiplexer in which the reflection mirror 170 in the optical multiplexer 100 of the first embodiment is replaced with a mirror array 260, and further includes a drive source 280 for displacing the mirror array 260 in the X direction and a controller 290 for controlling the drive source 280. Similarly to FIG. 3A, FIG. 6 is a view describing the internal configuration of the optical multiplexer 200 of the second embodiment from the viewpoint of the direction parallel to the Z direction, which is the wavelength dispersion direction.

Hereinafter, a configuration of the optical multiplexer 200 of the second embodiment different from that of the optical multiplexer 100 of the first embodiment will be selectively described, and description of the identical configuration will be appropriately omitted. Among the constituent elements of the optical multiplexer 200, the identical constituent elements to those of the optical multiplexer 100 of the first embodiment are given the identical reference numerals, and the detailed description thereof will be appropriately omitted.

The mirror array 260 of the optical multiplexer 200 in the present embodiment has a configuration in which a plurality of reflection mirrors 270 are arrayed in the X direction. Each of the reflection mirrors 270 is configured similarly to the reflection mirror 170 of the first embodiment. That is, similarly to the reflection mirror 170 of the first embodiment, the reflection mirror 270 includes the first reflection element 171 and the second reflection element 172 arrayed in the Z direction (see FIGS. 5A and 5B).

The first input port P_IN, the second input port P_AD, the first output port P_TH, the second output port P_DR, the transmission type diffraction grating 130, and the lens 150 in the optical multiplexer 200 are arranged similarly to those of the optical multiplexer 100 of the first embodiment.

The lens 150 is arranged so as to bring the in signal and the add signal into focus on one (hereinafter, expressed as a selection mirror) of the plurality of reflection mirrors 270 arranged at a normal position as in the first embodiment.

By displacement in the X direction of the mirror array 260, the selection mirror arranged at the normal position corresponding to the focal point of the lens 150 among the plurality of reflection mirrors 270 changes. The controller 290 controls the arrangement in the X direction of the mirror array 260 through control of the drive source 280 such that one reflection mirror 270 designated from the outside among the plurality of reflection mirrors 270 is arranged at the normal position.

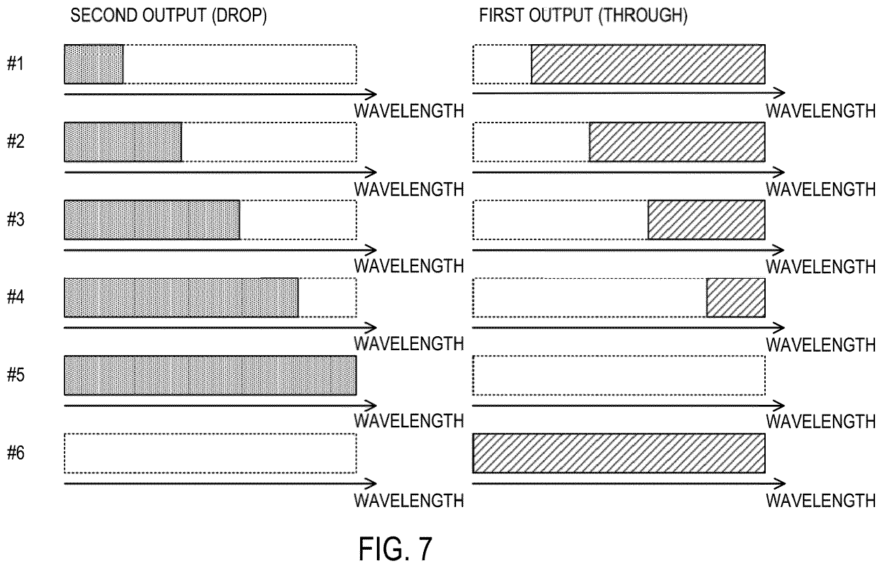

Here, a detailed configuration of the mirror array 260 will be described with reference to FIG. 7. Each of the plurality of reflection mirrors 270 arranged side by side in the X direction in the mirror array 260 has a configuration in which the first reflection element 171 and the second reflection element 172 are arranged such that combinations of the first wavelength band that is a transmission channel of a through signal and the second wavelength band that is a transmission channel of a drop/add signal are different between reflection mirrors 270.

According to the example shown in FIG. 7, in a case where six reflection mirrors 270 are arranged in the mirror array 260 and the first (#1) reflection mirror 270 is arranged at the normal position as the selection mirror, a signal components of the wavelength band of, for example, 20% on a short wavelength side (i.e., high frequency side) of the entire wavelength band of the in signal that can be reflected by the selection mirror propagates to the second output port P_DR as a signal component of the second wavelength band, and a wavelength component of the wavelength band of remaining 80% propagates to the first output port P_TH as a signal component of the first wavelength band.

For C=2, 3, or 4, in a case where the C-th (#C) reflection mirror 270 is arranged at the normal position as the selection mirror, a signal component of the wavelength band of, for example, 20×C % on the short wavelength side among of the entire wavelength band of the in signal propagates to the second output port P_DR as a signal component of the second wavelength band, and a wavelength component of the wavelength band of remaining (100−20×C) % propagates to the first output port P_TH as a signal component of the first wavelength band.

In a case where the fifth (#5) reflection mirror 270 is arranged at the normal position as the selection mirror, the first reflection element 171 does not substantially exist, and the entire wavelength band of the in signal propagates to the second output port P_DR as a signal component of the second wavelength band. In a case where the sixth (#6) reflection mirror 270 is arranged at the normal position as the selection mirror, the second reflection element 172 does not substantially exist, and the entire wavelength band of the in signal propagates to the first output port P_TH as a signal component of the first wavelength band.

According to this optical multiplexer 200, wavelength selection patterns of a transmission channel of the through signal and a transmission channel of the drop/add signal can be switched with a degree of freedom corresponding to the number of reflection mirrors 270 prepared in advance.

Although the optical multiplexer 200 is inferior to the optical multiplexer including a WSS in terms of the degree of freedom of wavelength selection, since the internal structure including the movable element is a simpler structure than the optical multiplexer including WSS, it is possible to achieve highly reliable operation for a long period of time with a low failure rate. Therefore, according to the present embodiment, it is possible to provide a wavelength-tunable optical multiplexer that is excellent overall in terms of insertion loss, reliability, and cost.

### Third Embodiment

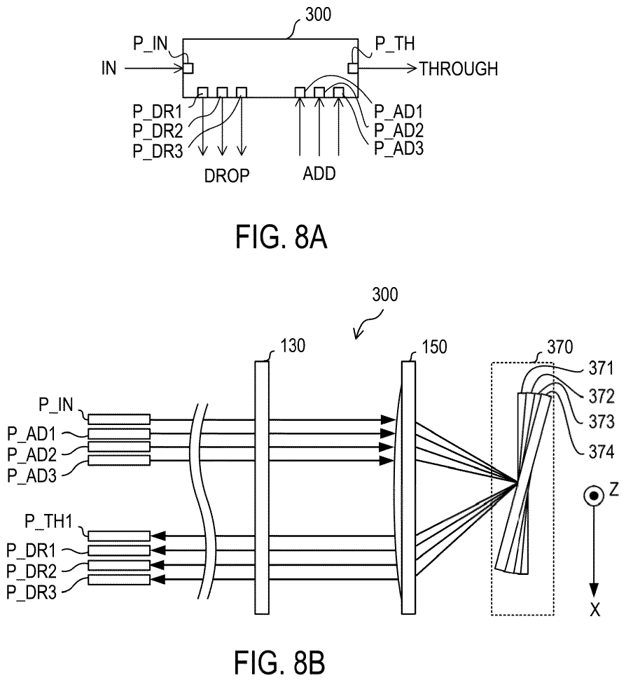

An optical multiplexer 300 of the third embodiment shown in FIGS. 8A and 8B is configured by providing the optical multiplexer 100 of the first embodiment with a plurality of add input ports P_AD1, P_AD2, and P_AD3 in place of the second input port P_AD, with a plurality of drop output ports P_DR1, P_DR2, and P_DR3 in place of the second output port P_DR, and with a reflection mirror 370 including first to fourth reflection elements 371 to 374 in place of the reflection mirror 170.

FIG. 8A shows that the optical multiplexer 300 is a 4-input 4-output optical multiplexer including the first input port P_IN, the first output port P_TH, the three add input ports P_AD1, P_AD2, and P_AD3, and the three drop output ports P_DR1, P_DR2, and P_DR3. Similarly to FIGS. 3A and 3B, FIG. 8B is a view describing the internal configuration of the optical multiplexer 300 of the third embodiment from the viewpoint of the direction parallel to the Z direction, which is the wavelength dispersion direction.

Hereinafter, a configuration of the optical multiplexer 300 of the third embodiment different from that of the optical multiplexer 100 of the first embodiment will be selectively described, and description of the identical configuration will be appropriately omitted. Among the constituent elements of the optical multiplexer 300, the identical constituent elements to those of the optical multiplexer 100 of the first embodiment are given the identical reference numerals, and the detailed description thereof will be appropriately omitted.

In the reflection mirror 370, the first reflection element 371, the second reflection element 372, the third reflection element 373, and the fourth reflection element 374 are arrayed in the Z direction as shown in FIG. 8B.

The first reflection element 371, the second reflection element 372, the third reflection element 373, and the fourth reflection element 374 are arranged in the Z direction such that, of the in signal and the add signal wavelength-dispersed by the transmission type diffraction grating 130 and transmitted through the lens 150, the first signal component corresponding to the first wavelength band is incident on the first reflection element 371, the second signal component corresponding to the second wavelength band is incident on the second reflection element 372, the third signal component corresponding to the third wavelength band is input to the third reflection element 373, and the fourth signal component corresponding to the fourth wavelength band is input to the fourth reflection element 374.

The add signal described in the present embodiment means a first add signal using the second wavelength band, a second add signal using the third wavelength band, and a third add signal using the fourth wavelength band. The first add signal is input from the first add input port P_AD1, the second add signal is input from the second add input port P_AD2, and the third add signal is input from the third add input port P_AD3.

The first reflection element 371 has a reflection surface inclined with respect to the X direction such that the propagation path of the first signal component of the in signal reflected by the first reflection element 371 is optically coupled to the first output port P_TH. The second reflection element 372 has a reflection surface inclined with respect to the X direction such that the propagation path of the second signal component of the in signal reflected by the second reflection element 372 is optically coupled to the first drop output port P_DR1.

The third reflection element 373 has a reflection surface inclined with respect to the X direction such that the propagation path of the third signal component of the in signal reflected by the third reflection element 373 is optically coupled to the second drop output port P_DR2. The fourth reflection element 374 has a reflection surface inclined with respect to the X direction such that the propagation path of the fourth signal component of the in signal reflected by the fourth reflection element 374 is optically coupled to the third drop output port P_DR3.

The first output port P_TH is provided in the propagation path of the reflected light by the first reflection element 371 of the first signal component of the in signal. The first drop output port P_DR1 is provided in the propagation path of the reflected light by the second reflection element 372 of the second signal component of the in signal. The second drop output port P_DR2 is provided in the propagation path of the reflected light by the third reflection element 373 of the third signal component of the in signal. The third drop output port P_DR3 is provided in the propagation path of the reflected light by the fourth reflection element 374 of the fourth signal component of the in signal.

With this optical configuration, the first signal component of the in signal reflected by the reflection mirror 370 is output from the first output port P_TH, the second signal component of the in signal is output from the first drop output port P_DR1, the third signal component of the in signal is output from the second drop output port P_DR2, and the fourth signal component of the in signal is output from the third drop output port P_DR3.

Furthermore, the second signal component of the first add signal reflected by the second reflection element 372, the third signal component of the second add signal reflected by the third reflection element 373, and the fourth signal component of the third add signal reflected by the fourth reflection element 374 propagate toward the first output port P_TH and are output from the first output port P_TH.

According to the present embodiment, the first add input port P_AD1 is arranged apart in the X direction from the first input port P_IN such that the propagation path of the second signal component of the first add signal reflected by the second reflection element 372 is optically coupled to the first output port P_TH.

The second add input port P_AD2 is arranged such that the propagation path of the third signal component of the second add signal reflected by the third reflection element 373 is optically coupled to the first output port P_TH. The third add input port P_AD3 is arranged such that the propagation path of the fourth signal component of the third add signal reflected by the fourth reflection element 374 is optically coupled to the first output port P_TH.

This, without a coupler, the optical multiplexer 300 branches the in signal into a through signal of the first wavelength band, a first drop signal of the second wavelength band, a second drop signal of the third wavelength band, and a third drop signal of the fourth wavelength band. Furthermore, the optical multiplexer 300 inserts and outputs, from the first output port P_TH, the first add signal of the second wavelength band, the second add signal of the third wavelength band, and the third add signal of the fourth wavelength band into the through signal of the first wavelength band.

Therefore, the optical multiplexer 300 can achieve optical communication by forming a multi-branch point by use as the OADM 10 in the WDM network. As a modification, the optical multiplexer 300 may include four or more add input ports and drop output ports. These add input ports and drop output ports may also be positioned and arranged in the X direction with the technical idea described above. That is, the optical multiplexer 300 may be configured as an M-input N-output optical multiplexer having M, which is 4 or more, input ports and N, which is 4 or more, output ports.

### Fourth Embodiment

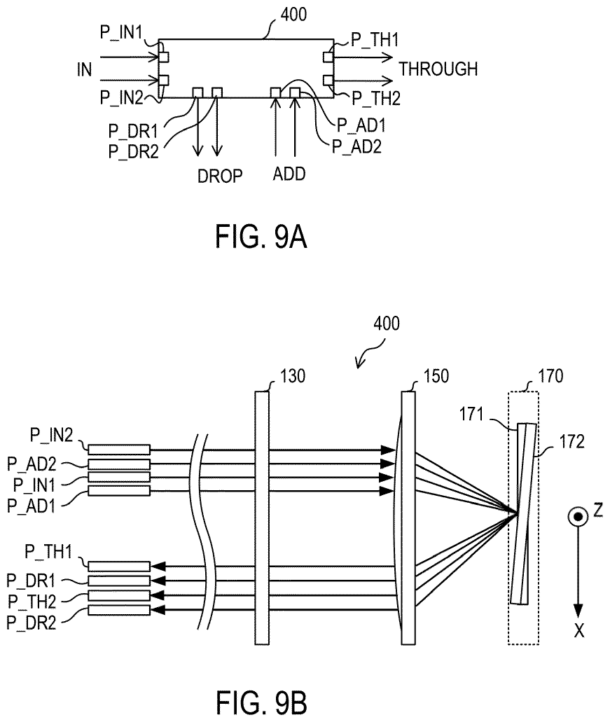

An optical multiplexer 400 of the fourth embodiment shown in FIGS. 9A and 9B is configured by providing the optical multiplexer 100 of the first embodiment with a plurality of main input ports P_IN1 and P_IN2 in place of the first input port P_IN, with a plurality of through output ports P_TH1 and P_TH2 in place of the first output port P_TH, with a plurality of add input ports P_AD1 and P_AD2 in place of the second input port P_AD, and with a plurality of drop output ports P_DR1 and P_DR2 in place of the second output port P_DR.

FIG. 9A shows that the optical multiplexer 400 is a 4-input 4-output optical multiplexer including the two main input ports P_IN1 and P_IN2, the two through output ports P_TH1 and P_TH2, the two add input ports P_AD1 and P_AD2, and the two drop output ports P_DR1 and P_DR2. Similarly to FIGS. 3A and 3B, FIG. 9B describes the internal configuration of the optical multiplexer 400 of the fourth embodiment from the viewpoint of the direction parallel to the Z direction, which is the wavelength dispersion direction.

Hereinafter, a configuration of the optical multiplexer 400 of the fourth embodiment different from that of the optical multiplexer 100 of the first embodiment will be selectively described, and description of the identical configuration will be appropriately omitted. Among the constituent elements of the optical multiplexer 400, the identical constituent elements to those of the optical multiplexer 100 of the first embodiment are given the identical reference numerals, and the detailed description thereof will be appropriately omitted.

In the optical multiplexer 400 of the present embodiment, a first in signal is input from the first main input port P_IN1. A second in signal is input from the second main input port P_IN2. The first add signal is input from the first add input port P_AD1, and the second add signal is input from the second add input port P_AD2.

The second main input port P_IN2 is arranged apart at a predetermined interval in the X direction perpendicular to the wavelength dispersion direction relative to the first main input port P_IN1.

The first in signal from the first main input port P_IN1, the first add signal from the first add input port P_AD1, the second in signal from the second main input port P_IN2, and the second add signal from the second add input port P_AD2 are wavelength-dispersed in the Z direction by the transmission type diffraction grating 130, and then enter the reflection mirror 170 through the lens 150.

The first signal component that is a group of wavelength components of the first wavelength band of the first in signal, the second in signal, the first add signal, and the second add signal having been wavelength-dispersed enters the first reflection element 171 of the reflection mirror 170, and is reflected by the reflection surface of the first reflection element 171.

The second signal component that is a group of wavelength components of the second wavelength band of the first in signal, the second in signal, the first add signal, and the second add signal having been wavelength-dispersed enters the second reflection element 172 of the reflection mirror 170, and is reflected by the reflection surface of the second reflection element 172.

The first through output port P_TH1 is arranged at a position to be optically coupled to the propagation path of the first signal component of the first in signal reflected by the first reflection element 171. The second through output port P_TH2 is arranged at a position to be optically coupled to the propagation path of the first signal component of the second in signal reflected by the first reflection element 171.

The first drop output port P_DR1 is arranged at a position to be optically coupled to the propagation path of the second signal component of the first in signal reflected by the second reflection element 172. The second drop output port P_DR2 is arranged at a position to be optically coupled to the propagation path of the second signal component of the second in signal reflected by the second reflection element 172.

With this arrangement, the first signal component of the first in signal is output from the first through output port P_TH1 as a first through signal, and the second signal component of the first in signal is output from the first drop output port P_DR1 as the first drop signal.

The first signal component of the second in signal is output from the second through output port P_TH2 as a second through signal, and the second signal component of the second in signal is output from the second drop output port P_DR2 as the second drop signal.

Furthermore, the second signal component of the first add signal reflected by the second reflection element 172 propagates toward the first through output port P_TH1 and is output from the first through output port P_TH1. The second signal component of the second add signal reflected by the second reflection element 172 propagates toward the second through output port P_TH2 and is output from the second through output port P_TH2.

For this, the first add input port P_AD1 is arranged apart in the X direction with respect to the first main input port P_IN1 such that the propagation path of the second signal component of the first add signal reflected by the second reflection element 172 is optically coupled to the first through output port P_TH1. The second add input port P_AD2 is arranged apart in the X direction with respect to the second main input port P_IN2 such that the propagation path of the second signal component of the second add signal reflected by the second reflection element 172 is optically coupled to the second through output port P_TH2. Additionally, the optical multiplexer 400 is designed such that the first signal components of the first and second add signals are not optically coupled to any output port.

Thus, the optical multiplexer 400 achieves the functions of the two optical multiplexers 100 by the transmission type diffraction grating 130, the lens 150, and the reflection mirror 170 that are common to the optical multiplexer 100.

Therefore, use of the optical multiplexer 400 as the OADM 10 in the WDM network can form a multi-branch point and achieve optical communication. Additionally, the optical multiplexer 400 may include three or more sets of the main input port, the through output port, the add input port, and the drop output port. The set of the main input port, the through output port, the add input port, and the drop output port may also be positioned with the technical idea described above.

### Fifth Embodiment

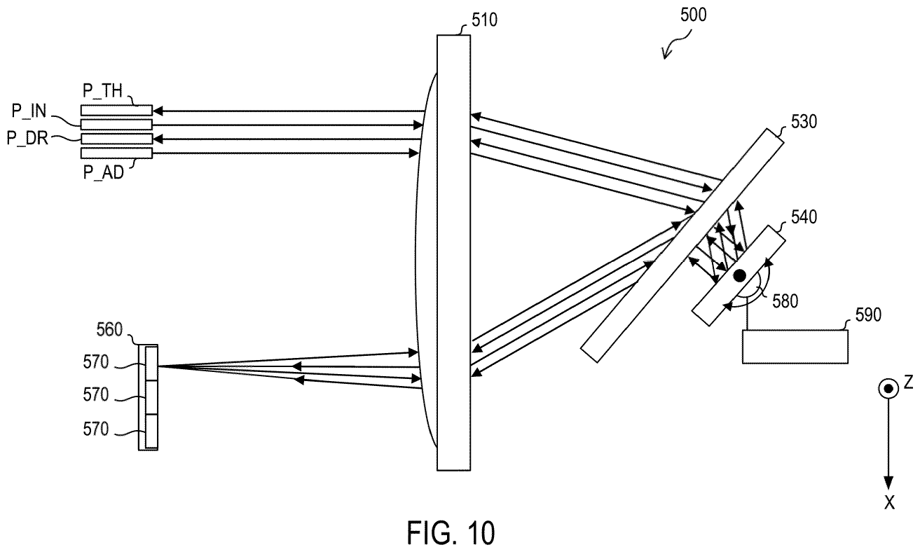

An optical multiplexer 500 of the fifth embodiment shown in FIG. 10 corresponds to a modification of the optical multiplexer 200 of the second embodiment, and functions as a wavelength-tunable optical multiplexer by controlling a propagation path of an optical signal by a movable mirror 540.

As shown in FIG. 10, the optical multiplexer 500 of the present embodiment includes the first input port P_IN, the first output port P_TH, the second input port P_AD, the second output port P_DR, a lens 510, a transmission type diffraction grating 530, the movable mirror 540, a mirror array 560, a drive source 580, and a controller 590.

The in signal from the first input port P_IN and the add signal from the second input port P_AD propagate to the transmission type diffraction grating 530 through the lens 510, and are wavelength-dispersed in the Z direction by the transmission type diffraction grating 530. The wavelength-dispersed in signal and add signal are reflected by the movable mirror 540, pass through the transmission type diffraction grating 530 and the lens 510 again, and enter the mirror array 560.

Similarly to the mirror array 260 of the second embodiment, the mirror array 560 has a configuration in which a plurality of reflection mirrors 570 are arrayed in the X direction. Each of the reflection mirrors 570 is configured similarly to the reflection mirror 170 of the first embodiment.

That is, each of the plurality of reflection mirrors 570 has a configuration in which the first reflection element 171 and the second reflection element 172 are arranged such that combinations of the first wavelength band that is a transmission channel of a through signal and the second wavelength band that is a transmission channel of a drop/add signal are different from each other.

According to the present embodiment, the movable mirror 540 functions as an optical deflector for changing or controlling the propagation direction of an optical signal. The in signal and the add signal reflected by the movable mirror 540 are incident on the mirror array 560 at a position in the X direction in accordance with the angle of the reflection surface of the movable mirror 540.

The drive source 580 can rotate the movable mirror 540, and is configured to be able to change the angle of the reflection surface of the movable mirror 540 with respect to the X direction by rotation. The drive source 580 is controlled by the controller 590.

The controller 590 controls the angle of the reflection surface of movable mirror 540 through drive source 580 such that the in signal and the add signal are incident on the selection mirror that is one reflection mirror 570 designated from the outside among the plurality of reflection mirrors 570 included in the mirror array 560.

The first signal components corresponding to the first wavelength band of the in signal and the add signal are reflected by the first reflection element 171 in the selection mirror. The propagation path of the reflected light by the first reflection element 171 of the first signal component of the in signal is optically coupled to the first output port P_TH.

The first signal component of the in signal reflected by the first reflection element 171 passes through the lens 510 and the transmission type diffraction grating 530, is reflected by the movable mirror 540, passes through the transmission type diffraction grating 530 and the lens 510 again, propagates to the first output port P_TH, and is output from the first output port P_TH.

The second signal components corresponding to the second wavelength band of the in signal and the add signal are reflected by the second reflection element 172 in the selection mirror. The propagation path of the reflected light by the second reflection element 172 of the second signal component of the in signal is optically coupled to the second output port P_DR.

The second signal component of the in signal reflected by the second reflection element 172 passes through the lens 510 and the transmission type diffraction grating 530, is reflected by the movable mirror 540, passes through the transmission type diffraction grating 530 and the lens 510 again, propagates to the second output port P_DR, and is output from the second output port P_DR.

The propagation path of the reflected light by the second reflection element 172 of the second signal component of the add signal is optically coupled to the first output port P_TH. Similarly to the other embodiments, this optical coupling is achieved by adjustment of the relative position in the X direction of the second input port P_AD with respect to the first input port P_IN.

The second signal component of the add signal reflected by the second reflection element 172 passes through the lens 510 and the transmission type diffraction grating 530, is reflected by the movable mirror 540, passes through the transmission type diffraction grating 530 and the lens 510 again, propagates to the first output port P_TH, and is output from the first output port P_TH.

According to the present embodiment, unlike the second embodiment, without displacing the mirror array 260 in the X direction, it is possible to input an in signal and an add signal to one of the plurality of reflection mirrors 570 in the mirror array 560 by controlling the reflection surface of the movable mirror 540.

According to the present embodiment, since the internal structure of the optical multiplexer 500 for achieving of being wavelength-tunable is simple as described above, it is possible to reduce the failure rate and enhance the reliability regarding the stable operation as compared with the optical multiplexer including a WSS.

While the illustrative embodiments of the present disclosure have been described above, the present disclosure is not limited to the above-described illustrative embodiments, and may be implemented in various forms.

For example, the technical idea regarding the mirror array 260 of the second embodiment may be applied to the optical multiplexer 300 of the third embodiment or the optical multiplexer of the fourth embodiment, whereby the optical multiplexer 300 or 400 may be configured as a wavelength-tunable optical multiplexer.

Functions of one element in the above embodiments may be distributed to two or more elements. Functions of two or more elements may be integrated in one element. A part of configurations of the above embodiments may be omitted. At least a part of the configurations of the above embodiments may be added to or replaced with the configurations of another embodiment or other embodiments of the above embodiments. Any and all modes included in the technical ideas identified by the languages recited in the claims are embodiments of the present disclosure.

1. An optical multiplexer comprising:
a first input port;
a second input port;
an optical dispersion element provided in a propagation path of first input light from the first input port and second input light from the second input port, and configured to separate each of first input light and second input light into a plurality of wavelength components by dispersing the first input light and the second input light in a predetermined wavelength dispersion direction;
a reflection mirror including a first reflection element and a second reflection element, the first reflection element being configured to reflect a group of wavelength components corresponding to a first wavelength band among the plurality of wavelength components separated by the optical dispersion element, the second reflection element being configured to reflect a group of wavelength components corresponding to a second wavelength band different from the first wavelength band in a direction different from the group of wavelength components corresponding to the first wavelength band of corresponding input light;
a first output port provided in a propagation path of first reflected light that is reflected light by the first reflection element of a group of wavelength components corresponding to the first wavelength band of the first input light, and configured to output the first reflected light; and
a second output port provided in a propagation path of second reflected light that is reflected light by the second reflection element of a group of wavelength components corresponding to the second wavelength band of the first input light, and configured to output the second reflected light, wherein
the reflection mirror reflects incident light in a direction different from an incident direction, and has a configuration in which the first reflection element and the second reflection element are arranged such that the first reflected light and the second reflected light propagate away in a direction perpendicular to the wavelength dispersion direction, and
the second input port is arranged at a position separated from the first input port in a direction perpendicular to the wavelength dispersion direction so that third reflected light that is reflected light by the second reflection element of a group of wavelength components corresponding to the second wavelength band of the second input light is optically coupled to the first output port and output from the first output port.

2. The optical multiplexer according to claim 1 comprising:
a mirror array including a plurality of reflection mirrors, each configured as the reflection mirror including the first reflection element and the second reflection element;
a drive element for displacing the mirror array; and
a controller configured to control an arrangement of the mirror array through the drive element, wherein
each of the plurality of reflection mirrors is a reflection mirror in which the first reflection element and the second reflection element are arranged such that combinations of the first wavelength band and the second wavelength band are different from each other between the plurality of reflection mirrors, and
the controller controls the arrangement of the mirror array so that the first input light and the second input light dispersed by the optical dispersion element are incident selectively on one designated reflection mirror among the plurality of reflection mirrors.

3. The optical multiplexer according to claim 1 comprising:
a mirror array including a plurality of reflection mirrors, each configured as the reflection mirror including the first reflection element and the second reflection element;
an optical deflector provided between the mirror array and the optical dispersion element, and configured to be able to change propagation directions to the mirror array of the first input light and the second input light dispersed by the optical dispersion element; and
a controller configured to control the propagation direction by control of the optical deflector, wherein
each of the plurality of reflection mirrors is a reflection mirror in which the first reflection element and the second reflection element are arranged such that combinations of the first wavelength band and the second wavelength band are different from each other between the plurality of reflection mirrors, and
the controller controls the optical deflector so that the first input light and the second input light dispersed by the optical dispersion element are incident selectively on one designated reflection mirror among the plurality of reflection mirrors.

4. The optical multiplexer according to claim 3, wherein
the optical deflector is a movable mirror, and
the controller controls the propagation direction by controlling an angle of a reflection surface of the movable mirror.
